(19) United States
(12) Patent Application Publication
(10) Pub. No.: US 2015/0109255 A1
(43) Pub. Date: Apr. 23, 2015

(54) OPTICAL TOUCH MODULE AND ASSEMBLY FORMED THEREFROM

(71) Applicant: Asia Vital Components Co., Ltd., New Taipei City (TW)

(72) Inventors: Cheng-Nan Lien, New Taipei City (TW); Jinhua Tan, New Taipei City (TW); Zijun Meng, New Taipei City (TW); Chih-Wei Chang, New Taipei City (TW)

(73) Assignee: Asia Vital Components Co., Ltd., New Taipei City (TW)

(21) Appl. No.: 14/056,953

(22) Filed: Oct. 18, 2013

(51) Int. Cl. G06F 3/042

(52) U.S. Cl. CPC G06F 3/042
USPC 345/175

(57) ABSTRACT

An optical touch assembly includes a plurality of optical touch modules connected to one another via L-shaped coupling plates to form a frame. Every optical touch module includes a light-emitting-diode (LED) circuit board having a plurality of LED elements mounted thereto and a control circuit board located below and overlapped with the LED circuit board. The L-shaped coupling plates connected to two opposite ends of each optical touch module are located below and overlapped with the LED circuit board. First connectors are provided on a bottom surface of the LED circuit board for correspondingly vertically connecting to second and third connectors provided on the control circuit board and the L-shaped coupling plates, respectively, so that intermediate spaces are formed in overlap areas between the LED circuit board and the control circuit board and the L-shaped coupling plates for mounting electronic elements and an extended section of a filter therein.

### FIELD OF THE INVENTION

The present invention relates to a touch module and assembly formed therefrom, and more particularly to an optical touch module and assembly formed therefrom.

### BACKGROUND OF THE INVENTION

Thanks to the upgraded light-emitting diode (LED) quality and the highly developed LED manufacturing process, the currently available optical touch technology has the advantages of high light transmittance, sensitive to touch by objects made of any material and suitable for large-size applications, and is now widely applied to various types of displays. According to the principles of the optical touch display, a plurality of optical touch modules are correspondingly mounted to two pairs of opposite sides of the display to serve as corresponding LED transmitters and receivers. The infrared LEDs located around the display create an x-y grid of densely distributed infrared light beams on the surface of the display screen. When an opaque object touches the display screen, the infrared light beams from the LED transmitters are blocked in the touched region, and the x and y coordinates of the touched region can be detected. Since each of the infrared LEDs is a single body and independent of other infrared LEDs, the light blocked position can be analyzed and located. Finally, through computation by a control circuit, a signal is sent to a personal computer connected to the touch display, so that the display screen outputs and shows the position that has just been touched or other software programs can be executed to control other signals for operation. The infrared touch panel has the advantage of high sensitivity to touch because it operates according to the blocking of the LED infrared signals and it is not necessary for a user to touch the substrate material of the panel to trigger a signal.

FIG. 1A is a top view of a conventional infrared touch assembly 10, which is in the form of a frame consisting of four strips of infrared touch modules 11. On each of two pairs of opposite sides of the frame, LED transmitters 12 and LED receivers 13 are correspondingly arranged. That is, every LED transmitter 12 corresponds to one LED receiver 13.

FIG. 1B is a sectional view taken along line X-X of FIG. 1A for showing a common structure of the infrared touch modules 11 of FIG. 1A. While the following description is made based on the infrared touch module 11 corresponding to FIG. 1B that has the LED transmitters 12 arranged thereon, it is noted the LED transmitters 12 are structurally identical to the LED receivers 13. As shown, the infrared touch module 11 each includes a control circuit board 111, an LED circuit board 112 located on a top of the control circuit board 111, and a plurality of LED transmitters 12 mounted to a top of the LED circuit board 112. The control circuit board 111 has a control integrated circuit (IC) provided thereon for controlling the LED transmitters 12 on the LED circuit board 112 to operate. The control circuit board 111 and the LED circuit board 112 are welded to each other, so that a plurality of first welding spots 15 is formed between the control circuit board 111 and the LED control circuit board 112 at predetermined positions. The first welding spots 15 not only connect the two circuit boards 111, 112 to each other, but also form paths via which electrical signals are transmitted between the two circuit boards 111, 112. Normally, in considering the transmission of electrical signals between the two circuit boards 111, 112, more than one first welding spot 15 is formed. Further, the solder used to weld the two circuit boards together is generally a metal having a relative low melting point, such as tin.

FIG. 1C is a perspective view of the optical touch assembly 10 of FIG. 1A showing more details of the frame assembled from four strips of infrared touch modules 11. As shown, the infrared touch modules 11 forming any two adjacent sides of the frame are connected together via an L-shaped coupling plate 16. In other words, four L-shaped coupling plates 16 form four corners of the frame of the infrared touch assembly 10, and every infrared touch module 11 has two L-shaped coupling plates 16 connected to two opposite ends thereof. More specifically, the four infrared touch modules 11 are connected to one another via the four L-shaped coupling plates 16 to form a frame.

FIG. 1D is a sectional view taken along line Y-Y of FIG. 1C. As shown, each of the four L-shaped coupling plates 16 is located below and welded to the control circuit boards 111 of two adjacent infrared touch modules 11, so that a plurality of second welding spots 17 is formed between the control circuit boards 111 and the L-shaped coupling plate 16. Electrical signals are transmitted between the four infrared touch modules 111 via the second welding spots 17.

Since each of the L-shaped coupling plates 16 is welded to the control circuit boards 111 of two adjacent infrared touch modules 11 and there are usually more than one first welding spot 15 and more than one second welding spot 17 to be formed, the forming of the frame of the infrared touch assembly 10 requires long welding operation time while it is uneasy to well control the welding quality. Moreover, since the LED circuit boards 112 are directly welded to the top of the control circuit boards 111, there is not any space left in overlap areas between the circuit boards 111, 112 for mounting any electronic element therein. That is, the conventional infrared touch assembly 10 with the above structure has many inactive areas and is disadvantageous in terms of circuit design, and the welded LED circuit boards 112 and control circuit boards 111 could not be disassembled for reworking or repair or maintenance.

It is therefore desirable to solve the above problems with the conventional infrared touch assembly.

### SUMMARY OF THE INVENTION

A primary object of the present invention is to provide an optical touch module, of which an LED circuit board and a control circuit board are detachably connected to each other via first and second connectors, which are correspondingly provided on two facing surfaces of the LED and control circuit boards, respectively. The detachably connected first and second connectors not only allow the transmission of electrical signals between the two circuit boards, but also allow the two circuit boards to be easily and accurately assembled and disassembled for reworking or maintenance without the risk of abnormal operation caused by poorly welded joints.

Another object of the present invention is to provide an optical touch module, of which an LED circuit board and a control circuit board are connected together via vertical engagement of two corresponding connectors, so that there is a vertical distance defined by the vertically engaged connectors between the two circuit boards and an intermediate space is formed in an overlap area between the two circuit boards, allowing electronic elements having a height smaller than that of any of the two connectors to be mounted in the intermediate space. The intermediate space also allows a lower extended section of a long strip of filter to be received therein, giving the whole optical touch module an enhanced assembling strength.

To achieve the above and other objects, the optical touch module according to the present invention includes an LED circuit board and a control circuit board. The LED circuit board has a first top surface having a plurality of LED elements mounted thereto, and a first bottom surface having at least one first connector provided thereon. The control circuit board is located below the LED circuit board, and has a second top surface and a second bottom surface. The second top surface is faced toward the first bottom surface of the LED circuit board, and has at least one second connector provided thereon for correspondingly connecting to the first connector to thereby connect the control circuit board to below the LED circuit board. Since the first and the second connector are vertically connected to each other, they together define a vertical distance between the LED circuit board and the control circuit board, and an intermediate space is formed in an overlap area between the first bottom surface and the second top surface. It is noted the first and the second connector are located within the intermediate space.

The present invention also provides an optical touch assembly. According to a first embodiment thereof, the optical touch assembly is formed from a plurality of optical touch modules and a plurality of L-shaped coupling plates arranged into a frame, such that each of the L-shaped coupling plates is connected at two ends to two of the optical touch modules that are located at two adjacent sides of the frame. Each of the optical touch modules includes an LED circuit board and a control circuit board. The LED circuit board has a first top surface and a first bottom surface. The first top surface has a plurality of LED elements mounted thereto, and the first bottom surface has at least one first connector provided thereon. The control circuit board is located below the LED circuit board and has a second top surface and a second bottom surface. The second top surface is faced toward the first bottom surface of the LED circuit board and has at least one second connector provided thereon for correspondingly connecting to the first connector. Each of the L-shaped coupling plates includes a third top surface, which is faced toward the first bottom surface of the LED circuit board and has at least one third connector provided thereon for correspondingly connecting to the first connector. The first connectors are vertically connected to the corresponding second connectors and third connectors to thereby connect the control circuit boards and the L-shaped coupling plates to below the LED circuit boards and define a vertical distance between the LED circuit boards and the control circuit boards and the L-shaped coupling plates, such that intermediate spaces are formed in overlap areas between the first bottom surfaces of the LED circuit boards and the second top surfaces of the control circuit boards, as well as in overlap areas between the first bottom surfaces of the LED circuit boards and the third top surfaces of the L-shaped coupling plates. It is noted the first, the second and the third connectors are located within the intermediate spaces.

According to a second embodiment thereof, the optical touch assembly of the present invention is formed from a plurality of optical touch modules, a plurality of L-shaped coupling plates, and a plurality of long strips of filters. The optical touch modules are arranged into a frame, and respectively include an LED circuit board and a control circuit. The LED circuit board has a first top surface having a plurality of LED elements mounted thereto and a first bottom surface having at least one first connector provided thereon. The control circuit board is located below the LED circuit board and has a second top surface and a second bottom surface. The second top surface is faced toward the first bottom surface of the LED circuit board and has at least one second connector provided thereon for correspondingly connecting to the first connector. The first connector is vertically connected to the corresponding second connector to thereby connect the control circuit board to below the LED circuit board and define a vertical distance between the LED circuit board and the control circuit board, such that an intermediate space is formed in an overlap area between the first bottom surface of the LED circuit board and the second top surface of the control circuit board. It is noted the first and the second connector are located within the intermediate space. Each of the L-shaped plates is connected at two ends to two optical touch modules that are located at two adjacent sides of the frame, and includes a third top surface, which is faced toward the first bottom surface of the LED circuit board and has at least one third connector provided thereon for correspondingly connecting to the first connector. The third connector is vertically connected to the corresponding first connector to thereby connect the L-shaped coupling plate to below the LED circuit board and define a vertical distance between the LED circuit board and the L-shaped coupling plate, such that an intermediate space is formed in an overlap area between the first bottom surface of the LED circuit board and the third top surface of the L-shaped coupling plate. It is noted the first and the third connector are located within the intermediate space. The filters are connected to the optical touch modules and the L-shaped coupling plates. Each of the filters includes a main body located in front of the LED elements, and an upper extended section and a lower extended section rearward extended from an upper and a lower edge of the main body, respectively, by a predetermined distance. The upper extended section is rearward extended to a top of the LED elements, and the lower extended section is extended into the intermediate spaces formed in the overlap areas between the first bottom surface of the LED circuit board and the second top surface of the control circuit board as well as between the first bottom surface of the LED circuit board and the third top surfaces of the L-shaped coupling plates.

With the above arrangements, the optical touch modules and the L-shaped coupling plates can be conveniently and accurately located and assembled into an optical touch assembly without the risk of abnormal operation caused by poor welded joints. Further, since the first connectors are detachably connected to the second and the third connectors, the optical touch assembly can be disassembled and then assembled again for reworking, repair or maintenance. The intermediate spaces provide rooms for mounting electronic elements and the filters, and the filters partially received in the intermediate spaces also give the whole optical touch assembly an enhanced assembling strength.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a top view of a conventional infrared touch assembly;

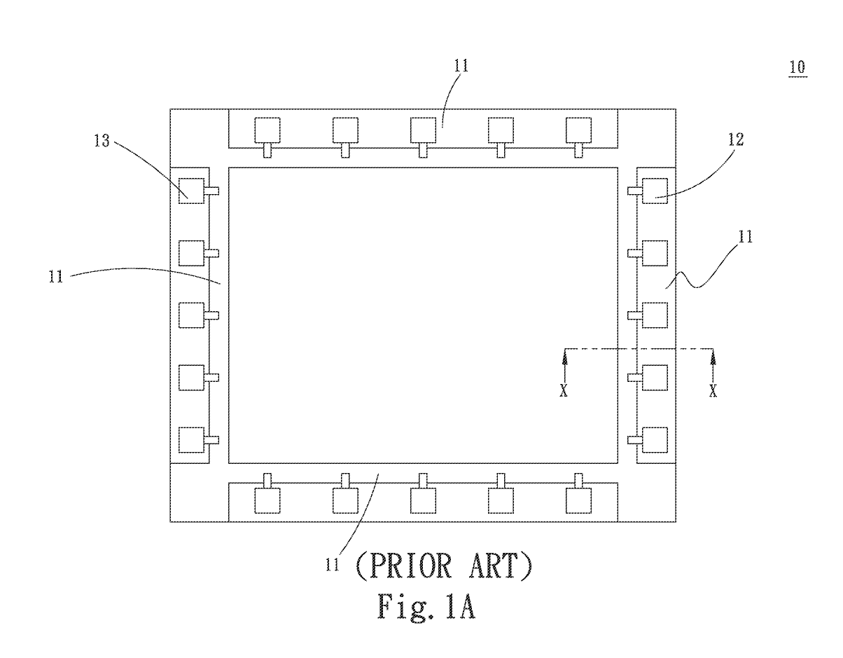

FIG. 1B is a sectional view taken along line X-X of FIG. 1A;

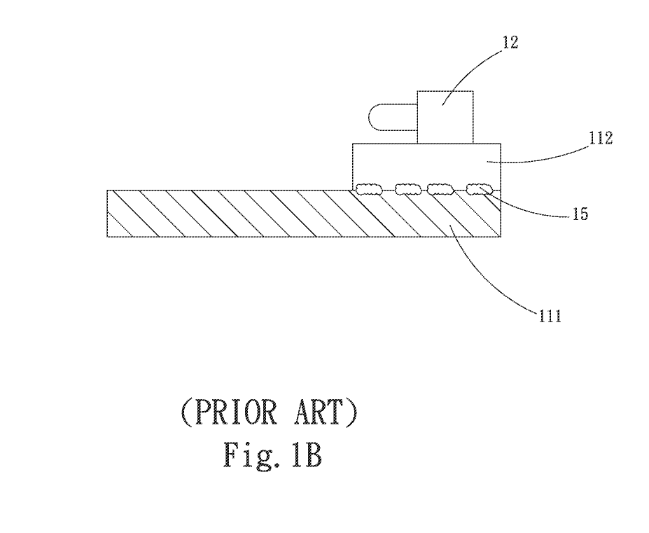

FIG. 1C is a perspective view of the optical touch assembly of FIG. 1A;

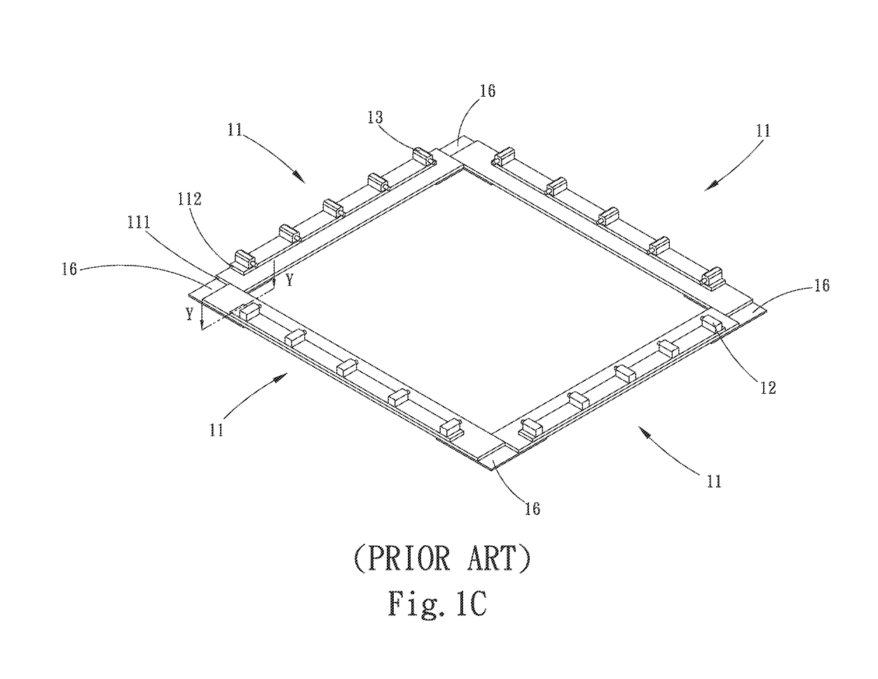

FIG. 1D is a sectional view taken along line Y-Y of FIG. 1C;

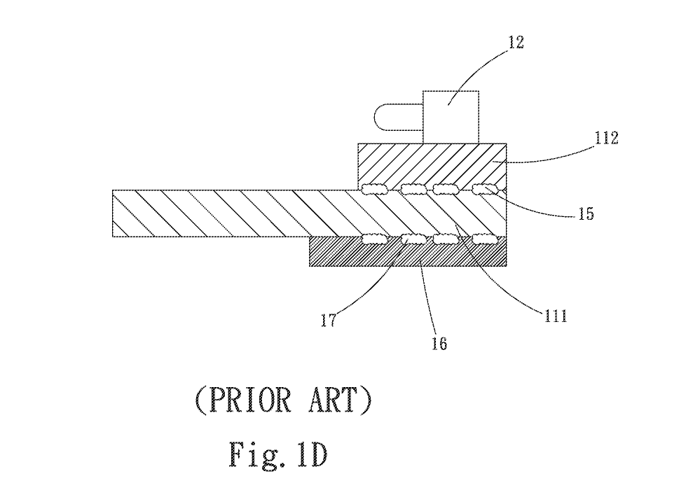

FIG. 2 is an exploded side view of an optical touch module according to the present invention;

FIG. 3A is an assembled view of FIG. 2;

FIG. 3B is a fragmentary, assembled front view of the optical touch module according to the present invention;

FIG. 4 is an exploded perspective view of an optical touch assembly according to the present invention;

FIG. 5A is a fragmentary, exploded front view of the optical touch assembly of FIG. 4;

FIG. 5B is an assembled view of FIG. 5A;

FIG. 6A is a cutaway view of the optical touch assembly of the present invention with a filter mounted thereto;

FIG. 6B is a fragmentary, exploded front view of FIG. 6A; and

FIG. 6C is a perspective view of the filter shown in FIG. 6A.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

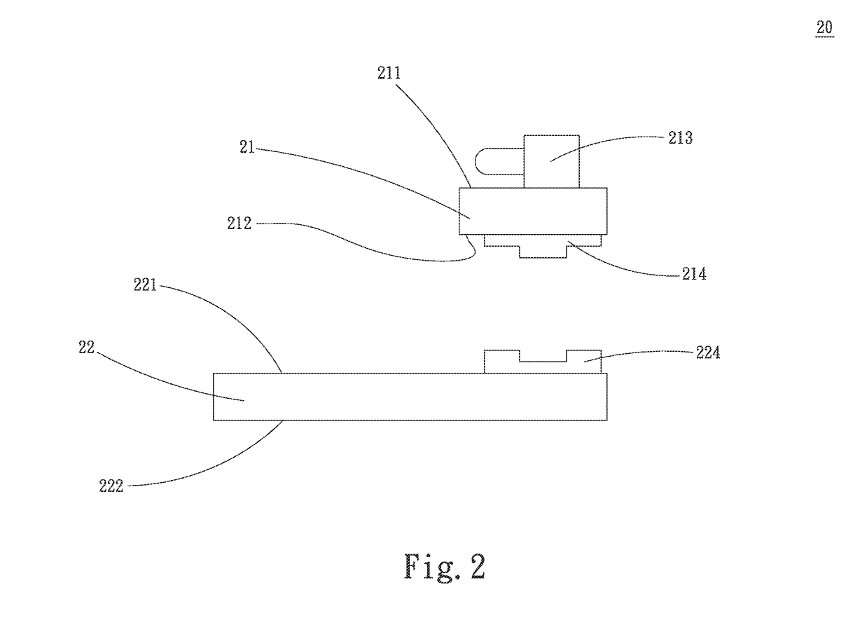

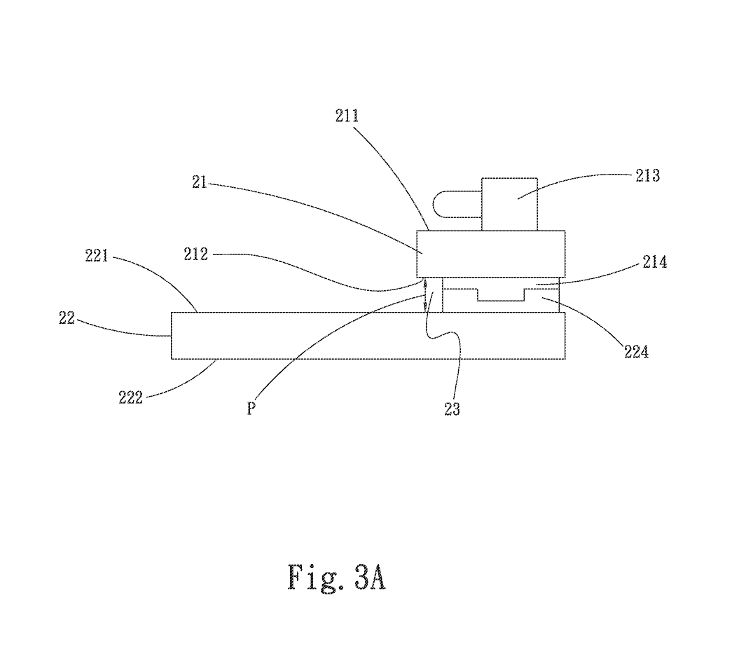

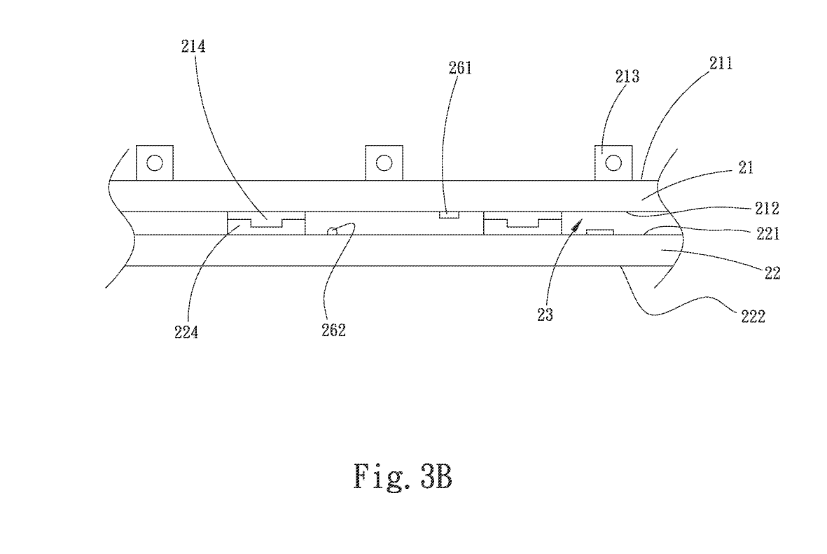

Please refer to FIG. 2, which is an exploded side view of an optical touch module 20 according to the present invention; and to FIG. 3A, which is an assembled view of FIG. 2. As shown, the optical touch module 20 includes a light-emitting-diode (LED) circuit board 21 and a control circuit board 22. The LED circuit board 21 has a first top surface 211, on which a plurality of LED elements 213 is mounted, and a first bottom surface 212, on which at least one first connector 214 is provided. The control circuit board 22 is located below the LED circuit board 21 and has a second top surface 221 and a second bottom surface 222. The second top surface 221 is faced toward the first bottom surface 212 of the LED circuit board 21 and has at least one second connector 224 provided thereon for correspondingly connecting to the first connector 214.

The first connector 214 may be a male connector. In this case, the second connector 224 is a female connector for correspondingly engaging with the male connector. Alternatively, the first connector 214 may be a female connector. Then, the second connector 224 shall be a male connector for correspondingly engaging with the female connector. Since the first connector 214 and the corresponding second connector 224 are detachably connected to each other, they provide good flexibility in the connection of the LED circuit board 21 to the control circuit board 22 and in the replacement of any of the LED circuit board 21 and the control circuit board 22. By “connector”, it means a medium, such as a socket, a jack, a terminal or a bundle of cables, for electrically connecting two or more objects together. That is, the term “connector” used herein generally refers to all kinds of connecting elements and accessories thereof used to transmit electronic signals and electric power. The connector serves as a bridge to connect or communicate blocked or isolated circuits with one another, so as to energize the circuits and achieve expected electrical functions.

Through vertical engagement of the first connector 214 with the second connector 224, the control circuit board 22 is connected to below the LED circuit board 21. The engaged first and second connectors 214, 224 together define a vertical distance p, so that an intermediate space 23 is formed in an overlap area between the first bottom surface 212 of the LED circuit board 21 and the second top surface 221 of the control circuit board 22. The first and the second connector 214, 224 are located within the intermediate space 23.

Please refer to FIG. 3B, which is a fragmentary, assembled front view of the optical touch module 20 according to the present invention. As shown, at least one electronic element having a height lower than that of the first connector 214 or that of the second connector 224 can be mounted within the intermediate space 23. In FIG. 3B, an electronic element 261 is mounted to the first bottom surface 212 of the LED circuit board 21 at a position not interfered by the first connector 214; and another electronic element 262 is mounted to the second top surface 221 of the control circuit board 22 at a position not interfered by the second connector 224. Both of the electronic elements 261, 262 are located within the intermediate space 23 after the LED circuit board 21 is connected to the control circuit board 22 via engagement of the first and second connectors 214, 224 with one another.

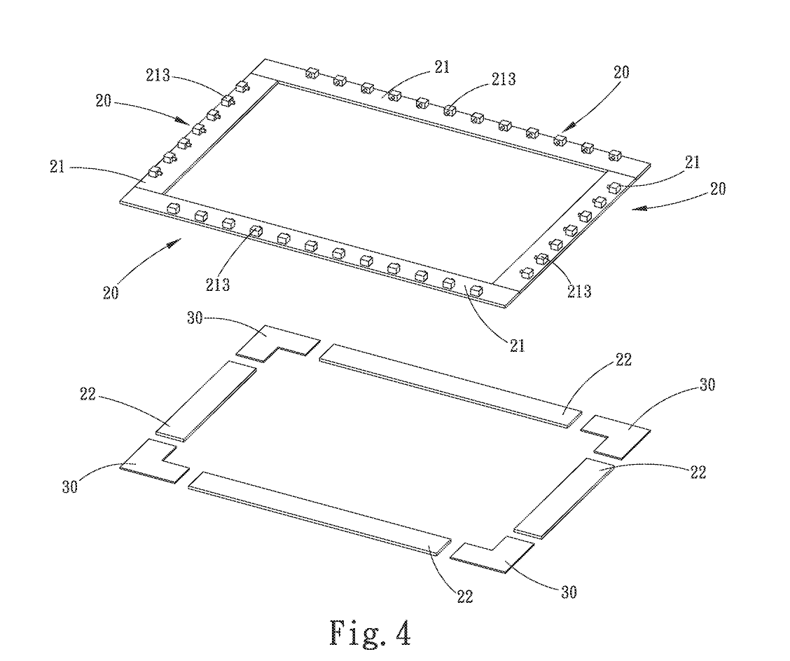

The present invention also provides an optical touch assembly, an exploded perspective view of which is shown in FIG. 4. As shown, the optical touch assembly is formed from four pieces of the above-described optical touch modules 20 and four pieces of L-shaped coupling plates 30, which are arranged into a frame. The four L-shaped coupling plates 30 serve as four corners of the frame-shaped optical touch assembly. More specifically, each of the four L-shaped coupling plates 30 is coupled with two optical touch modules 20 located at two adjacent sides of the frame. In other words, each of the optical touch modules 20 is connected at two opposite ends to two L-shaped coupling plates 30. The LED elements 213 on the optical touch modules 20 located at two opposite sides of the frame are corresponding to one another in position. More specifically, the LED elements 213 located on one side of the frame serve as infrared transmitters while the LED elements 213 correspondingly located on the opposite side of the frame serve as infrared receivers.

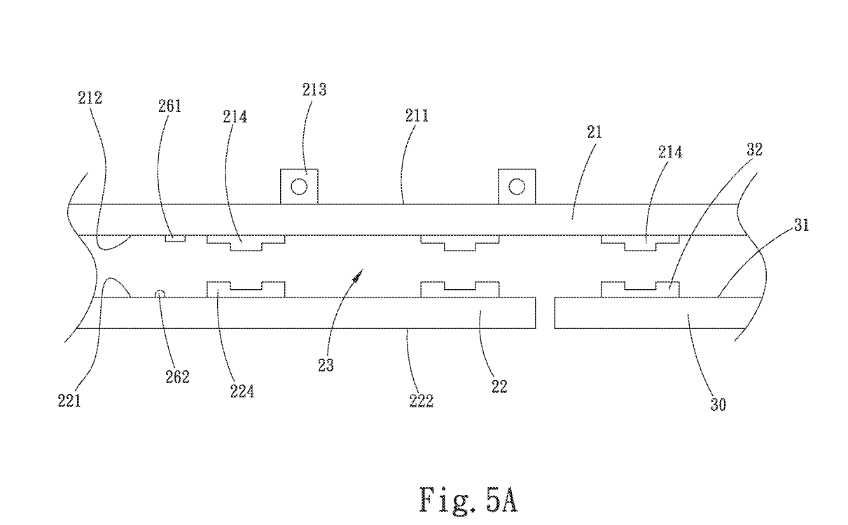

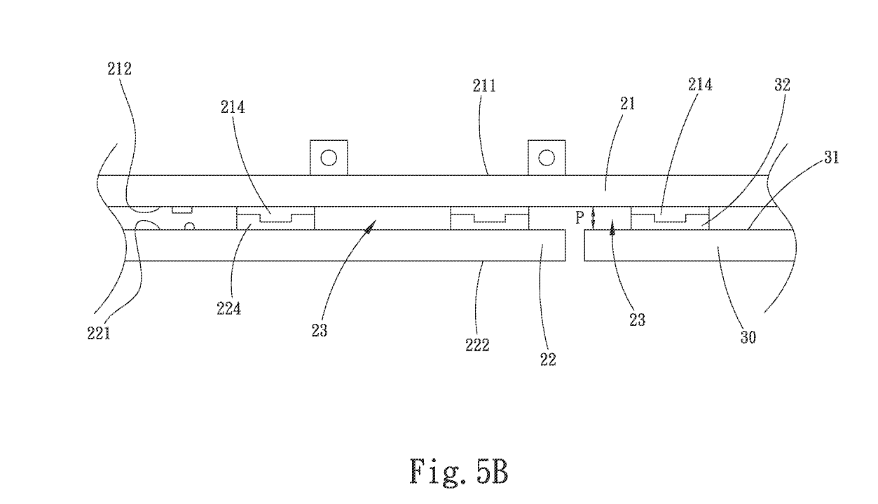

Please refer to FIGS. 5A and 5B, which are fragmentary, exploded and assembled front views, respectively, of the optical touch assembly of the present invention. Two L-shaped coupling plates 30 are located at and spaced from two opposite ends of the control circuit board 22 of every optical touch module 20. In the illustrated FIGS. 5A and 5B, only one end of the control circuit board 22 with the L-shaped coupling plate 30 is shown. The L-shaped coupling plate 30 each has a third top surface 31, on which at least one third connector 32 is mounted.

In every optical touch module 20, the first bottom surface 212 of the LED circuit board 21 is faced toward the second top surface 221 of the control circuit board 22 and the third top surfaces 31 of the L-shaped coupling plates 30, and the first connectors 214 are vertically connected to the second connectors 224 and the third connectors 32, such that the control circuit board 22 and the L-shaped coupling plates 30 are connected to below the LED circuit board 21.

Therefore, the vertical distance p defined by two engaged connectors exists not only between the LED circuit board 21 and the control circuit board 22, but also between the LED circuit board 21 and the L-shaped coupling plates 30. Accordingly, in addition to the intermediate space 23 formed in the overlap area between the first bottom surface 212 and the second top surface 221, there are also intermediate spaces 23 formed in overlap areas between the first bottom surface 212 and the third top surfaces 31. And, the first, the second and the third connectors 214, 224, 32 all are located within the intermediate spaces 23.

The electronic element 261 mounted to the first bottom surface of every LED circuit board 21 and the electronic element 262 mounted to the second top surface of every control circuit board are also located within the intermediate space 23, as having been mentioned above.

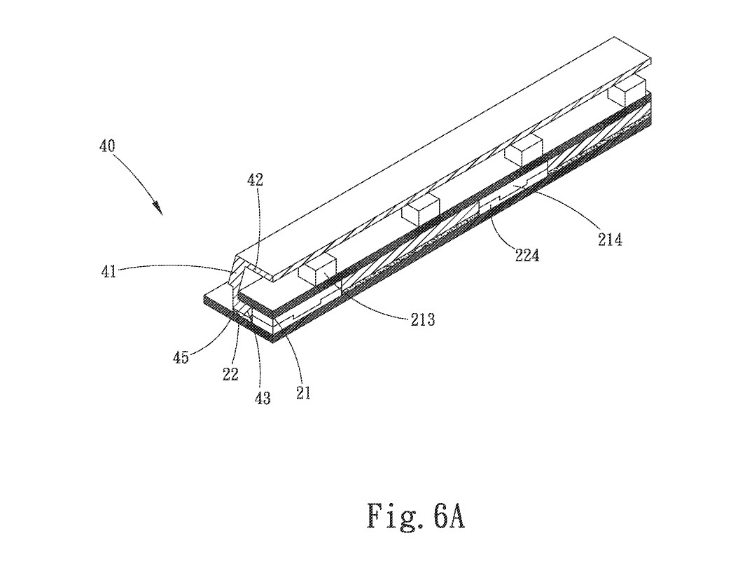

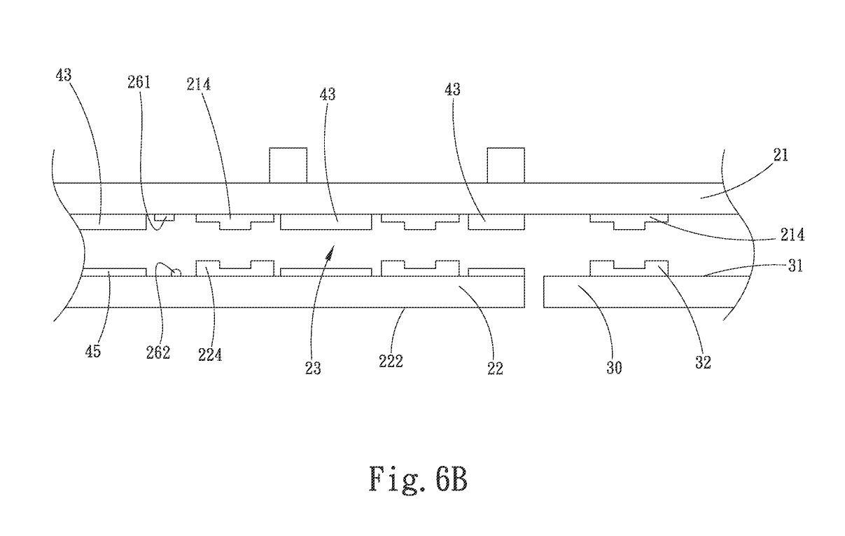

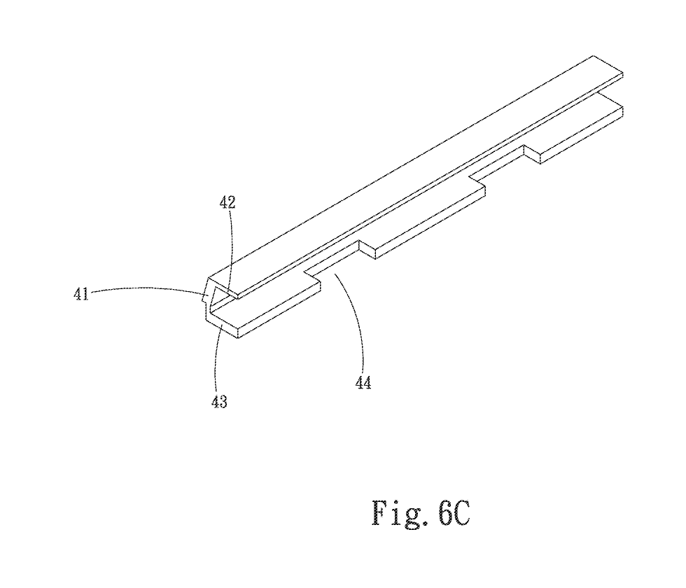

According to the present invention, the optical touch assembly further includes a long strip of filter 40 mounted to every optical touch module 20 in front of the LED elements 213 thereof for shielding the latter from interference by environmental light. FIGS. 6A and 6B are fragmentary cutaway view and fragmentary exploded front view, respectively, of one optical touch module 20 of the optical touch assembly of the present invention with a filter 40 mounted thereto; and FIG. 6C is a perspective view of the filter 40. The filter 40 can be, for example, an infrared filter made of a plastic material doped with a dye. Generally, there are two types of filters 40. The first type is a high-pass filter that allows light having a wavelength larger than 850 nm or 940 nm to pass therethrough; and the second type is a narrow-band pass filter that allows light having a wavelength between 925-955 nm to pass therethrough. However, it is understood the above-mentioned infrared filter is only illustrative and not intended to limit the material or the type of the filter 40 for the present invention. The filter 40 can be any filter that is currently known in the art.

The filter 40 each includes an elongated main body 41, and an upper extended section 42 and a lower extended section 43 that are rearwardly extended from an upper and a lower edge of the main body 41, respectively, by a predetermined length. The upper extended section 42 is extended to a position above the LED elements 213, the main body 41 is transversely located in front of the LED elements 213, and the lower extended section 43 is extended into the intermediate space 23 between the first bottom surface 212 of the LED circuit board 21 and the second top surface 221 of the control circuit board 22 as well as the intermediate spaces 23 between the first bottom surface 212 of the LED circuit board 21 and the third top surfaces 31 of the coupling plates 30.

As can be seen in FIG. 6C, the lower extended section 43 includes a plurality of notches 44, which are located corresponding to the first connectors 214, the second connectors 224, the third connectors 32 and the electronic elements 261, 262 in the intermediate spaces 23. With this arrangement, the lower extended section 43 would not interfere with the first connectors 214, the second connectors 224, the third connectors 32 and the electronic elements 261, 262. As can be seen in FIGS. 6A and 6B, an adhesive layer 45 is provided between an underside of the lower extended section and the control circuit board 22. The adhesive layer 45 is double-sided for bonding the lower extended section 43 to the control circuit board 22. According to the present invention, the adhesive layer 45 can be, for example, a double-sided adhesive tape or other functionally equivalent elements.

In brief, the present invention provides an optical touch module 20 and a frame-shaped optical touch assembly formed by connecting a plurality of the optical touch modules 20 via a plurality of L-shaped coupling plates 30. In the optical touch assembly, each of the optical touch modules 20 includes an LED circuit board 21 and a control circuit board 22 detachably connected to each other via first and second connectors 214, 224, and the LED circuit board 21 each is detachably connected to two L-shaped coupling plates 30 via first and third connectors 214, 32. Electrical signals can be transmitted between the LED circuit boards 21 and the control circuit boards 22 via the engaged first and second connectors 214, 224, and between the optical touch modules 20 via the engaged first and third connectors 214, 32. Since the first connectors 214 are detachably connected to the second and the third connectors 224, 32, the optical touch modules 20 can be conveniently located and assembled without the risk of abnormal operation caused by poorly welded joints, and the optical touch assembly can be easily disassembled and assembled again for reworking or repair or maintenance. The provision of the first, second and third connectors 214, 224, 32 also defines a vertical distance p between two facing surfaces of the LED circuit boards 21 and the control circuit boards 22 and the coupling plates 30, and accordingly create intermediate spaces 23 in overlap areas between them. Electronic elements having a height smaller than that of the first, second and third connectors can be mounted to the LED circuit boards 21 and the control circuit boards 22 within the intermediate space 23; and long strips of filters 40 can be mounted in front of the LED elements 213 on the optical touch modules 20 with lower extended sections 43 of the filters 40 extended into the intermediate spaces 23 to give the whole optical touch assembly further enhanced assembling strength.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An optical touch module, comprising:
an LED circuit board having a first top surface and a first bottom surface, the first top surface having a plurality of LED elements mounted thereto, and the first bottom surface having at least one first connector provided on; and
a control circuit board being located below the LED circuit board and having a second top surface and a second bottom surface; and the second top surface being faced toward the first bottom surface of the LED circuit board and having at least one second connector provided thereon for correspondingly connecting to the first connector;
wherein the first and the corresponding second connector are vertically connected to each other to thereby connect the control circuit board to below the LED circuit board and define a vertical distance between the LED circuit board and the control circuit board, such that an intermediate space is formed in an overlap area between the first bottom surface of the LED circuit board and the second top surface of the control circuit board; and wherein the first and the second connector are located within the intermediate space.

2. The optical touch module as claimed in claim 1, wherein the first bottom surface of the LED circuit board has at least one electronic element mounted thereto within the intermediate space.

3. The optical touch module as claimed in claim 1, wherein the second top surface of the control circuit board has at least one electronic element mounted thereto within the intermediate space.

4. The optical touch module as claimed in claim 1, wherein the overlap area between the first bottom surface of the LED circuit board and the second top surface of the control circuit board has at least one electronic element mounted thereto.

5. The optical touch module as claimed in claim 1, wherein the intermediate space allows an extended section of a long strip of filter to be received therein.

6. The optical touch module as claimed in claim 5, wherein the extended section of the filter has at least one notch provided at a position corresponding to the at least one first connector and the at least one second connector.

7. The optical touch module as claimed in claim 1, wherein the first connector is one of a male and a female connector; and the second connector is one of a female and a male connector corresponding to the first connector.

8. An optical touch assembly, comprising a plurality of optical touch modules and a plurality of L-shaped coupling plates arranged into a frame, such that each of the L-shaped coupling plates is connected at two ends to two of the optical touch modules that are located at two adjacent sides of the frame;
each of the optical touch modules including:
an LED circuit board having a first top surface and a first bottom surface, the first top surface having a plurality of LED elements mounted thereto, and the first bottom surface having at least one first connector provided thereon; and
a control circuit board being located below the LED circuit board and having a second top surface and a second bottom surface; and the second top surface being faced toward the first bottom surface of the LED circuit board and having at least one second connector provided thereon for correspondingly connecting to the first connector; and
each of the L-shaped coupling plates including:
a third top surface being faced toward the first bottom surface of the LED circuit board, and having at least one third connector provided thereon for correspondingly connecting to the first connector;
wherein the L-shaped coupling plates connected to two opposite ends of each optical touch module are located at and spaced from two opposite ends of the control circuit board of the optical touch module; and
wherein the first connectors are vertically connected to the corresponding second connectors and third connectors to thereby connect the control circuit boards and the L-shaped coupling plates to below the LED circuit boards and define a vertical distance between the LED circuit boards and the control circuit boards and the L-shaped coupling plates, such that intermediate spaces are formed in overlap areas between the first bottom surfaces of the LED circuit boards and the second top surfaces of the control circuit boards, as well as in overlap areas between the first bottom surfaces of the LED circuit boards and the third top surfaces of the L-shaped coupling plates; and wherein the first, the second and the third connector are located within the intermediate spaces.

9. The optical touch assembly as claimed in claim 8, wherein the first bottom surfaces of the LED circuit boards have at least one electronic element mounted thereto within the intermediate spaces.

10. The optical touch assembly as claimed in claim 8, wherein the second top surfaces of the control circuit boards have at least one electronic element mounted thereto within the intermediate spaces.

11. The optical touch assembly as claimed in claim 8, wherein the overlap areas between the first bottom surfaces of the LED circuit boards and the second top surfaces of the control circuit boards have at least one electronic element mounted thereto.

12. The optical touch assembly as claimed in claim 8, further comprising a plurality of long strips of filters, and the filters respectively having an extended section received in the intermediate spaces.

13. The optical touch assembly as claimed in claim 12, wherein the extended sections of the filters respectively have a plurality of notches provided at positions corresponding to the first connectors, the second connectors and the third connectors.

14. The optical touch assembly as claimed in claim 8, wherein the first connectors are respectively one of a male and a female connector; and the second connectors and the third connectors are respectively one of a female and a male connector corresponding to the first connector.

15. An optical touch assembly, comprising:
a plurality of optical touch modules being arranged into a frame and respectively including:
an LED circuit board having a first top surface and a first bottom surface, the first top surface having a plurality of LED elements mounted thereto, and the first bottom surface having at least one first connector provided thereon; and
a control circuit board being located below the LED circuit board and having a second top surface and a second bottom surface; and the second top surface being faced toward the first bottom surface of the LED circuit board and having at least one second connector provided thereon for correspondingly connecting to the first connector; and
the first connector being vertically connected to the corresponding second connector to thereby connect the control circuit board to below the LED circuit board and define a vertical distance between the LED circuit board and the control circuit board, such that an intermediate space is formed in an overlap area between the first bottom surface of the LED circuit board and the second top surface of the control circuit board; and the first and the second connector being located within the intermediate space;
a plurality of L-shaped plates, each of which including:
a third top surface being faced toward the first bottom surface of the LED circuit board, and having at least one third connector provided thereon for correspondingly connecting to the first connector; each of the L-shaped coupling plates being connected at two ends to two optical touch modules that are located at two adjacent sides of the frame, and the L-shaped coupling plate located at each of two opposite ends of every optical touch module being located at and spaced from an end of the control circuit board of the optical touch module; and
the third connector being vertically connected to the corresponding first connector to thereby connect the L-shaped coupling plate to below the LED circuit board and define a vertical distance between the LED circuit board and the L-shaped coupling plate, such that an intermediate space is formed in an overlap area between the first bottom surface of the LED circuit board and the third top surface of the L-shaped coupling plate; and the first and the third connector being located within the intermediate space; and
a plurality of long strips of filters being mounted to the optical touch modules and respectively including:
a main body being located in front of the LED elements; and
an upper extended section and a lower extended section rearward extended from an upper and a lower edge of the main body, respectively, by a predetermined distance; the upper extended section being rearward extended to a top of the LED elements, and the lower extended section being extended into the intermediate spaces formed between the first bottom surface of the LED circuit board and the second top surface of the control circuit board, as well as between the first bottom surface of the LED circuit board and the third top surfaces of the L-shaped coupling plates.

16. The optical touch assembly as claimed in claim 15, wherein the extended sections of the filters respectively have a plurality of notches provided at positions corresponding to the first connectors, the second connectors and the third connectors.

17. The optical touch assembly as claimed in claim 15, wherein the lower extended sections of the filters received in the intermediate spaces are bonded on respective underside to the control circuit boards via an adhesive layer.

18. The optical touch assembly as claimed in claim 15, wherein the first bottom surfaces of the LED circuit boards have at least one electronic element mounted thereto within the intermediate spaces.

19. The optical touch assembly as claimed in claim 15, wherein the second top surfaces of the control circuit boards have at least one electronic element mounted thereto within the intermediate spaces.

20. The optical touch assembly as claimed in claim 15, wherein the overlap areas between the first bottom surfaces of the LED circuit boards and the second top surfaces of the control circuit boards have at least one electronic element mounted thereto.

21. The optical touch assembly as claimed in claim 15, wherein the first connectors are respectively one of a male and a female connector; and the second connectors and the third connectors are respectively one of a female and a male connector corresponding to the first connector.
